(19) United States
(12) Patent Application Publication
(10) Pub. No.: US 2025/0384181 A1
(43) Pub. Date: Dec. 18, 2025

(54) CRUDE BLENDING, OPTIMIZATION AND FORECASTING TOOL FOR FIELD DEVELOPMENT PLANNING

(71) Applicant: Saudi Arabian Oil Company, Dhahran (SA)

(72) Inventors: Inemesit Ekong, Dhahran (SA); Thamer M. Rafie, Dhahran (SA)

(21) Appl. No.: 18/745,102

(22) Filed: Jun. 17, 2024

(51) Int. Cl. G06F 30/20; G06F 111/10; G06F 113/08

(52) U.S. Cl. CPC G06F 30/20; G06F 2111/10; G06F 2113/08

(57) ABSTRACT

A computer-implemented method for providing a crude blending, optimization, and forecasting tool is described. One or more feedstocks or components of a petroleum production network are selected using a graphical user interface of a crude blend engine (CBE). The CBE receives input data for one or more feedstocks or components of a petroleum production network and calculates, using the input data for a blend of fluid from the one or more feedstocks or components, total blend production rate and crude blend properties. The CBE calculates, using the total blend production rate and crude blend properties, an estimation of blend fluid properties and crude grade classification for the blend of fluid. The CBE initiates for display the estimation of blend fluid properties and crude grade classification on a computer display graphical user interface. The CBE initiates a blending operation to achieve a target crude grade classification.

### BACKGROUND

Petroleum crude oils are a mixture of many organic compounds, and their overall properties differ between wells. The overall properties are typically defined based on their physical and chemical characteristics, including: density (API gravity), Sulphur content, viscosity, acidity-total acid number (TAN), true boiling point (TBP), compositions, wax content, sediment, and water. The actual quality of crude and a crude grade classification is represented by these properties and determine a mix of the product obtained and ease of processing, transporting, and refining.

In a diverse and complex hydrocarbon portfolio consisting of multi-fields/complexes targeting multi-reservoirs with varying crude quality, field development and production strategy, processing, transportation, storage, and refining operations can be very challenging if crude oil production from various reservoirs/fields are not appropriately selected and optimally blended to achieve a desired life cycle crude grade of a combined mix while maintaining target production levels.

### SUMMARY

The present disclosure describes providing a crude blending, optimization, and forecasting tool.

In an implementation, a computer-implemented method for providing a crude blending, optimization, and forecasting tool, comprising: selecting, using a graphical user interface initiated for display by a crude blend engine (CBE), one or more feedstocks or components of a petroleum production network; receiving, by the CBE, input data for each of one or more feedstocks or components of a petroleum production network; calculating, by the CBE and using the input data for a blend of fluid from the one or more feedstocks or components of a petroleum production network, total blend production rate and crude blend properties; calculating, by the CBE and using the total blend production rate and crude blend properties, an estimation of blend fluid properties and crude grade classification for the blend of fluid; initiating for display, by the CBE on a computer display graphical user interface, the estimation of blend fluid properties and crude grade classification; and initiating, by the CBE, a blending operation to achieve a target crude grade classification.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages.

First, the described approach provides a workflow and a software-based analytic tool (e.g., a Crude Blending, Optimization, and Forecasting (CBO&F) Tool implemented in SPOTFIRE) for crude blending and optimization solutions generated for single or multi-fields targeting multi-reservoirs with multi-crude grades considering crude quality variation (forecast) over production life cycle, while maintaining desired production strategy and production levels for field development planning. The approach's model utilizes crude oil production forecasts from single or multi-fields targeting multi-reservoirs with varying crude quality, and applies volumetric and mass balance equations to estimate crude mix fluid properties using two fluid physical parameters, namely density (API Gravity) and Sulphur Content. Applying crude grade classification criteria, a resultant crude mix is categorized and a crude quality variation can be tracked over a production life cycle of a field or reservoir, which provides vital information for field development planning and decision making.

Second, the described approach provides a standardized workflow and quick analysis for establishing: 1) crude grade for various crude blend assessment of single or multi-fields targeting multi-reservoirs with varying crude quality; 2) crude grade forecast for tracking variation over a production life cycle of a project; 3) crude blend optimization by evaluating a minimum crude mixing ratio (minimum diluent rate) required to achieve a desired life cycle crude grade from a combined blend under various production scenarios while maintaining target production levels; and 4) a product price differential impact of a resultant crude blend over the production life cycle of the project for economic evaluation.

Third, the CBO&F Tool can enhance decision making on complex crude blending and optimization of single or multi-fields targeting multi-reservoirs with varying crude quality. In some implementations, the CBO&F Tool can also be used to initiate, control, manage, or stop a blending operation to achieve a target crude grade classification.

Fourth, the described approach can assist with making technical decisions. For example, and in some implementations, technical decisions can include those for development strategy and optimization; decision making on production strategy, transportation, and storage; and enhancement of decision making on processing and refining operating efficiency.

Fifth, the described approach can assist with making economic/commercial decisions. For example, and in some implementations, economic/commercial decisions can include those for enhancement of decision making on marketing strategy, establishment of a product price differential impact for economic evaluation, and maximizing premium crude and project value (NCF).

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a table illustrating crude oil classification criteria, according to an implementation of the present disclosure.

FIG. 2 is a diagram illustrating a workflow for crude oil blending and forecasting, according to an implementation of the present disclosure.

FIG. 3 is a diagram illustrating workflow for crude blending and optimization (minimum mixing ratio), according to an implementation of the present disclosure.

FIG. 4 is an illustration of a Crude Blending, Optimization, and Forecasting (CBO&F) Tool canvas, according to an implementation of the present disclosure.

FIG. 5 is an illustration of a CBO&F Tool workflow and crude blending engine (CBE), according to an implementation of the present disclosure.

FIG. 6 is an illustration of a CBO&F Tool crude blend modeling canvas, according to an implementation of the present disclosure.

FIG. 7 is an illustration of a CBO&F Tool crude blend optimization modeling canvas, according to an implementation of the present disclosure.

FIG. 8 is an illustration of a CBO&F Tool crude blend optimization modeling and plots canvas, according to an implementation of the present disclosure.

FIG. 9 is an illustration of a CBO&F Tool crude blend product price differential forecast canvas, according to an implementation of the present disclosure.

FIG. 10 is a flowchart illustrating an example of a computer-implemented method for providing a crude blending, optimization, and forecasting software tool, according to an implementation of the present disclosure.

FIG. 11 is a block diagram illustrating an example of a computer-implemented system used to provide computational functionalities associated with described algorithms, methods, functions, processes, flows, and procedures, according to an implementation of the present disclosure.

FIG. 12 illustrates hydrocarbon production operations that include both one or more field operations and one or more computational operations, which exchange information and control exploration for the production of hydrocarbons.

Like reference numbers and designations in the various drawings indicate like elements.

### DETAILED DESCRIPTION

The following detailed description describes providing a crude blending, optimization, and forecasting software tool and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Petroleum crude oils are a mixture of many organic compounds, and their overall properties differ between wells. The overall properties are typically defined based on their physical and chemical characteristics, including: density (API gravity), Sulphur content, viscosity, acidity-total acid number (TAN), true boiling point (TBP), compositions, wax content, sediment, and water. The actual quality of crude and a crude grade classification is represented by these properties and determine a mix of the product obtained and ease of processing, transporting, and refining.

In a diverse and complex hydrocarbon portfolio consisting of multi-fields/complexes targeting multi-reservoirs with varying crude quality, field development and production strategy, processing, transportation, storage, and refining operations can be very challenging if crude oil production from various reservoirs/fields are not appropriately selected and optimally blended to achieve a desired life cycle crude grade of a combined mix while maintaining target production levels.

A described approach provides a workflow and a software tool for crude blending and optimization solutions generated for single or multi-fields targeting multi-reservoirs with multi-crude grades considering crude quality variation (forecast) over production life cycle, while maintaining desired production strategy and production levels for field development planning. The approach's model utilizes crude oil production forecasts from single or multi-fields targeting multi-reservoirs with varying crude quality, and applies volumetric and mass balance equations to estimate crude mix fluid properties using two fluid physical parameters, namely API gravity and Sulphur Content. Applying crude grade classification criteria, a resultant crude mix is categorized and a crude quality variation can be tracked over a production life cycle of a field or reservoir, which provides vital information for field development planning and decision making.

A standardized workflow and quick analysis is provided for establishing: 1) crude grade for various crude blend assessment of single or multi-fields targeting multi-reservoirs with varying crude quality; 2) crude grade forecast for tracking variation over a production life cycle of a project; 3) crude blend optimization by evaluating a minimum crude mixing ratio (minimum diluent rate) required to achieve a desired life cycle crude grade from a combined blend under various production scenarios while maintaining target production levels; and 4) a product price differential impact of a resultant crude blend over the production life cycle of the project for economic evaluation.

A software-based analytic tool (i.e., a Crude Blending, Optimization, and Forecasting (CBO&F) Tool (e.g., implemented in SPOTFIRE) can be used to enhance decision making on complex crude blending and optimization of single or multi-fields targeting multi-reservoirs with varying crude quality. In some implementations, the CBO&F Tool can also be used to initiate, control, manage, or stop a blending operation to achieve a target crude grade classification.

The CBO&F Tool can also be used to assist with making technical decisions. For example, and in some implementations, technical decisions can include those for development strategy and optimization; decision making on production strategy, transportation, and storage; and enhancement of decision making on processing and refining operating efficiency. The CBO&F Tool can also be used to assist with making economic/commercial decisions. For example, and in some implementations, economic/commercial decisions can include those for enhancement of decision making on marketing strategy, establishment of a product price differential impact for economic evaluation, and maximizing premium crude and project value (NCF).

The described approach and CBO&F Tool permit an improvement in ensuring consistency of chemical combinations to achieve a desired crude grade that is not possible manually (i.e., it is not practical to perform the method as described in the human mind with enough speed/accuracy to approach the inventive concept results). This is especially true due to at least the complexity of multi-fields/complexes targeting multi-reservoirs with varying crude quality, field development and production strategy, processing, transportation, storage, and refining operations, which are not possible/practical to perform manually and/or in the human mind with required consistency, accuracy, and speed.

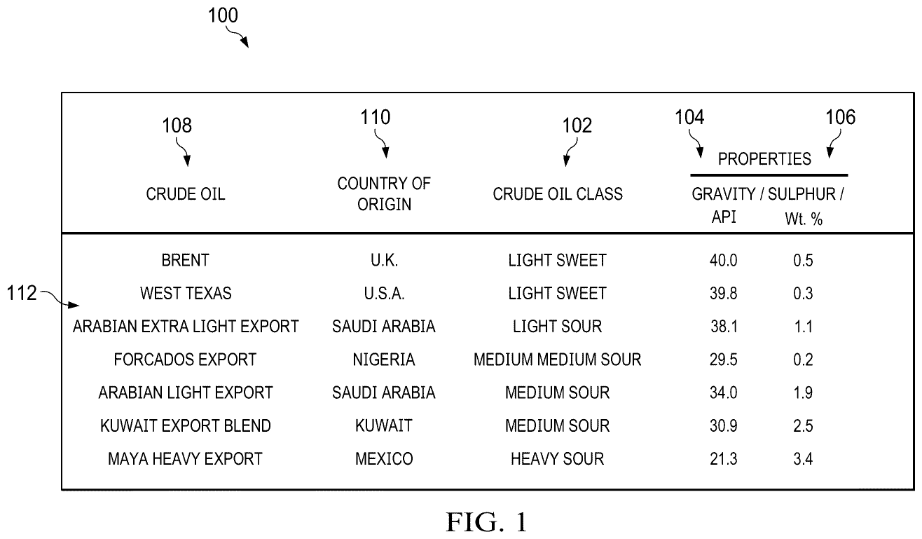

Turning to FIG. 1, FIG. 1 is a table 100 illustrating crude oil classification criteria, according to an implementation of the present disclosure.

In table 100, a crude oil classification 102 (e.g., Light Sweet, Light Sour, and Heavy Sour) is based on crude oil classification criteria including density (API gravity) 104 and Sulphur content 106. A magnitude or value of each of these two properties can vary between country or area of operation (e.g., Crude Oil source 108 and Country of Origin 110). As a particular example, row 112 indicates that Arabian Extra Light Export crude oil from Saudi Arabia is classified as “Light Sour” and has an API gravity of 39.8 and Sulphur content of 1.1%.

### Crude Blending and Optimization

Crude oil blending is a process of mixing two or more crude petroleum components together with an aim to improve an overall value or a quality of a blend. An optimization process consists in determining optimal proportions to be blended from a set of available crude feedstocks (i.e., reservoirs) or components, such that a final product obtained fulfills a set of specifications with respect to properties of the final product.

In some implementations, crude oil blending can be accomplished by two methods: 1) on-line blending: components/feedstock from separate pipelines are mixed in a single export line with an in-line static mixer or mechanical mixing device used for ensuring homogenous mixture and 2) tank blending: components/feedstocks are blended in export tanks using tank mixer for ensuring a homogenous mixture. Typical Crude Assay and properties include: 1) unrefined (on-line blending)—sampling and measurement are obtained from an export pipeline and 2) refined tank blending—sampling and measurement are obtained from an export tank.

### Crude Blending and Forecasting Workflow

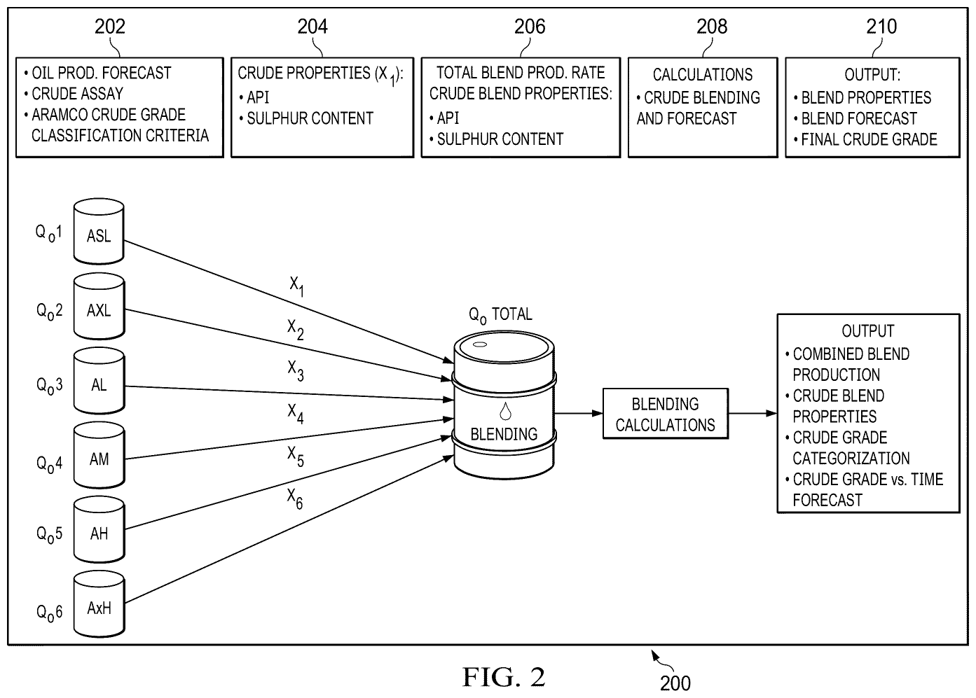

FIG. 2 is a diagram illustrating a workflow 200 for crude oil blending and forecasting, according to an implementation of the present disclosure. Workflow 200 establishes a resultant crude oil grade from a combined mix or blend of selected feedstocks by entailing input data from each feedstock or component. The CBO&F Tool can be used to automate algorithms for estimation of the blend fluid properties and crude grade classification and to initiate one or more operations in a petroleum production network.

At 202, input data from each feedstock or component of the petroleum production network can include oil production forecast, crude fluid properties from crude assay and crude grade classification criteria. For example, crude grade classification criteria could be that of SAUDI ARAMCO: 1. ASL (Arabian Super Light); 2) AXL (Arabian Extra Light); 3) AL (Arabian Light); 4) AM (Arabian Medium); and 5) AH (Arabian Heavy). In some implementations, the CBO&F Tool includes a software crude blend engine (CBE). The CBO&F Tool can be used, through a graphical user interface (GUI) initiated for display by the crude blend engine (CBE), to select one or more feedstocks or components of the petroleum production network;

At 204, crude oil properties (e.g., API gravity and Sulphur content) are considered for mixing/blending. The crude oil properties/input data is stored in one or more databases accessible by the CBE. The CBE can receive, the crude oil properties as input data for each of one or more feedstocks or components. From 202/204, workflow 200 proceeds to 206.

At 206, selected feedstocks are then blended or mixed. In some implementations, blending can be done in-line (export pipeline) or at a refinery (tank). Total blend production rate and crude blend properties are then calculated by the CBE using the input data for a blend of fluid from the one or more feedstocks or components. From 206, workflow 200 proceeds to 208.

At 208, mathematical blending equations are applied to estimate blended fluid properties over a life cycle of the blended feedstock (206). In other words, the CBE calculates, using the total blend production rate and crude blend properties, an estimation of blend fluid properties and crude grade classification for the blend of fluid.

In some implementations, API gravity of the blend is estimated by:

$${X}_{{mix}_{,} j} = \frac{{\sum }_{i = 1}^{n} ( {Q}_{i , j} * {X}_{i , j} )}{{\sum }_{i = 1}^{n} ( {Q}_{i , j} )} , \qquad Eq . ( 1 )$$

where: Xₘᵢₓ=API of the blend of fluid, Qᵢ=Oil Rate, [symbol] ₒᵢ=Oil specific gravity, i=Feedstock for i=1 to n, j=Time step for j=1 to n years.

In some implementations, the Sulphur content of the blend is estimated by:

$${Y}_{{mix}_{,} j} = \frac{{\sum }_{i = 1}^{n} ( {Q}_{i , j} * {oi , j}_{} * {Y}_{i , j} )}{{\sum }_{i = 1}^{n} ( {Q}_{i , j} * {oi , j}_{} )} \qquad Eq . ( 2 )$$

where: Yₘᵢₓ=Sulphur Content of the blend of fluid, Qᵢ=Oil Rate, [symbol] ₒᵢ=Oil specific gravity, i=Feedstock for i=1 to n, and j=Time step for j=1 to n years.

The CBE can be used to calculate, using total blend production rate and crude blend properties, an estimation of blend fluid properties and crude grade classification for the blend of fluid. In some implementations, a crude grade classification is estimated by:

$${Z}_{mix , j} = f ( {X}_{mix , j} , {Y}_{mix , j} ) , \qquad Eq . ( 3 )$$

where: Xₘᵢₓ=API of the blend of fluid, Yₘᵢₓ=Sulphur Content of the blend of fluid, Zₘᵢₓ=Crude Grade of the blend of fluid, Qᵢ=Oil Rate, [symbol] ₒᵢ=Oil specific gravity, i=Feedstock for i=1 to n, and j=Time step for j=1 to n years.

The crude oil grade classification criteria (e.g., as illustrated in FIG. 1) can be used by the CBE to categorize a resultant crude oil blend. From 208, workflow 200 proceeds to 210.

At 210, workflow 200 output includes combined blend production rates, crude blend fluid properties, crude grade categorization, and a forecast over a production life cycle. The CBE can initiate for display an estimation of blend fluid properties and crude grade classification on a computer display graphical user interface. In some implementations, the CBE can also be used to initiate, control, manage, or stop a blending operation to achieve a target crude grade classification. For example, the CBE can automatically and/or directly interface with one or more petroleum production network components (e.g., valves, pumps, mixers, and storage tanks) to initiate the start of a blending operation to cause crude blending according to the calculated combined blend production rates, crude blend fluid properties, crude grade categorization, and forecast over a production life cycle. After 210, workflow 200 can stop.

### Crude Blending and Optimization (Minimum Mixing Ratio) Workflow

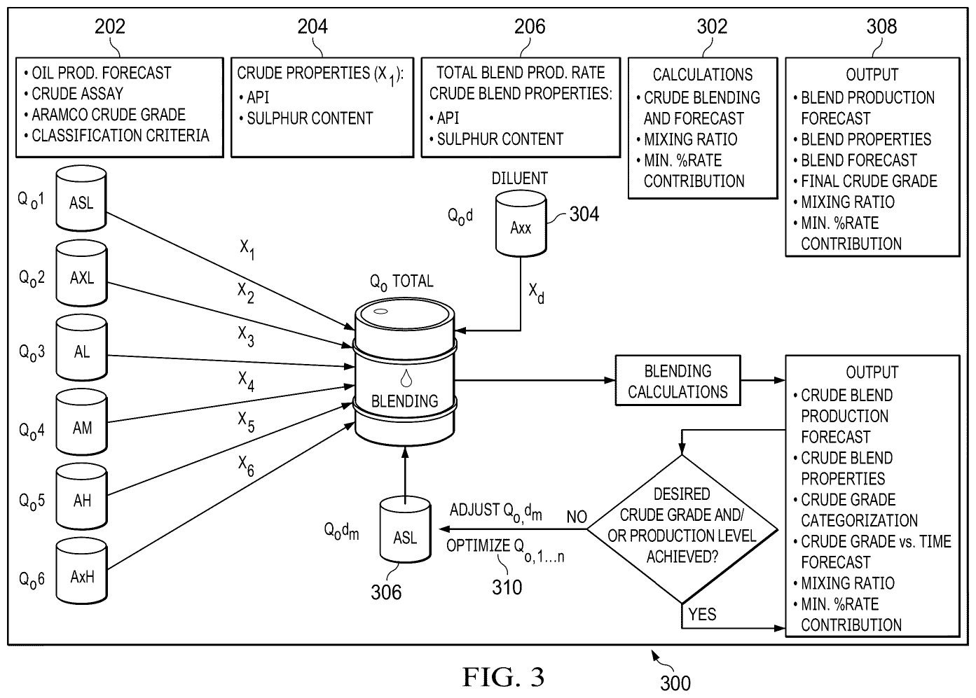

FIG. 3 is a diagram illustrating workflow 300 for crude blending and optimization (minimum mixing ratio), according to an implementation of the present disclosure.

For 202, 204, and 206 of workflow 300, please refer to descriptions in FIG. 2.

At 302, in workflow 300 a diluent or lighter crude oil (e.g., dilutant 304 or lighter crude oil 306) can be introduced in the crude mix/blend. Note that, in some implementations, the diluent can be single or multi-crude grade feedstock (in which case it also needs to be blended to achieve the desired crude grade using Eq. (1)-(3) as described in step 208 of FIG. 2).

Optimization mathematical equations/algorithms are then used to evaluate a minimum mixing or blending ratio required to achieve a desired combined crude grade while maintaining target production levels. Optimization functionality for workflow 300 is modelled by defining an objective function, decision variable, and constraints. A solver optimization algorithm is used in establishing a minimum mixing ratio or required diluent contribution to achieve a desired life cycle crude grade.

In some implementations, the CBO&F Tool model utilizes optimization equations to establish a minimum mixing ratio and a re-estimation of a resultant crude blend (feedstock) fluid properties and crude grade categorization. For example, the CBE can, using the target crude grade classification and into a blend of fluid, as a new blend of fluid, a lighter crude oil or diluent feedstock and, using Eq. (1-(3), establish a new crude grade classification of the new blend of fluid, such that:

$${Z}_{d mix , j} = f ( {X}_{d , mix , j} , {Y}_{d mix , j} ) , \qquad Eq . ( 4 )$$

$$Minimize = \frac{{\sum }_{i = 1}^{n} {Q}_{d i , j}}{{\sum }_{i = 1}^{n} {Q}_{mix i , j}} , and \qquad Eq . ( 5 )$$

$${MR}_{, j}$$

$$Subject to : 0 < {MR}_{, j} \leq 100 , \qquad Eq . ( 6 )$$

$$Desired / Target Blend , {Z}_{{mix}_{,} j} = {Z}_{{{mix}_{,}}^{″} j} . \qquad Eq . ( 7 )$$

where: X_{d mix}=API of the new blend of fluid with diluent, Y_{d mix}=Sulphur Content of the new blend of fluid with diluent, Z_{d mix}=Crude Grade of the new blend of fluid with diluent, Q_{d}=Diluent Oil Rate, Qₘᵢₓ=Combined blended Oil Rate with diluent, MR=Mixing Ratio of diluent to combined blended volume, i=Feedstock for i=1 to n, j=Time step for j=1 to n years.

The CBE can use the crude grade classification criteria to re-evaluate the combined blend and to categorize the crude grade classification of the new blend of fluid:

$${Z}_{mix , j} = f ( {X}_{i , mix} , {Y}_{i , mix} ) , \qquad Eq . ( 8 )$$

where: X_{d mix}=API of the new blend of fluid with diluent, Y_{d mix}=Sulphur Content of the new blend of fluid with diluent, Z_{d mix}=Crude Grade of the new blend of fluid with diluent, i=Feedstock for i=1 to n, and j=Time step for j=1 to n years.

At 308, workflow 300 output includes, in the described implementation, crude blend production forecast, crude blend properties, crude grade categorization, crude grade vs. time forecast, mixing ratio, and minimum % rate contribution. The CBE can initiate the output of workflow 300 for display on a computer display graphical user interface if a determination is made that a desired crude oil grade and/or production level has been achieved. After 308, workflow 300 can stop.

In some implementations, the CBE can calculate a life cycle price differential of the new blend of fluid, assessing a life cycle product price impact based on the result from the crude blending and optimization. The CBO&F Tool model can use a product price differential equation derived from multiple regression analysis carried out on historical crude mix fluid properties, crude grade, and price differentials. In some implementations, a life cycle price differential of a resultant crude mix (new blend of fluid) from Eq. (3) or Eq. (4) can be estimated using:

$${P}_{d mix , j} = a * {X}_{d , mix , j} - b * {Y}_{d mix , j} - c , \qquad Eq . ( 9 )$$

where: P_{d mix}=Price differential of resultant crude mix, X_{d mix}=API of the new blend of fluid with diluent, Y_{d mix}=Sulphur Content of the new blend of fluid with diluent, a, b, c=Coefficients of a multiple regression analysis, j=Time step for j=1 to n years.

If a determination is made that a desired crude oil grade and/or production level has not been achieved, an adjustment/optimization operation(s) can be performed at 310 (e.g., adding additional diluent and/or lighter crude oil) to adjust a blend closer to the desired crude oil grade and/or production level.

In some implementations, the CBE of workflow 300 can also be used to initiate, control, manage, or stop a blending operation (including adding a diluent and lighter crude oil) to achieve a target crude grade classification. For example, the CBE can automatically and/or directly interface with one or more petroleum production network components (e.g., valves, pumps, mixers, and storage tanks) to initiate the start of a blending operation to cause crude blending and/or addition of a diluent/lighter crude oil according to the calculated combined blend production rates, crude blend fluid properties, crude grade categorization, and forecast over a production life cycle.

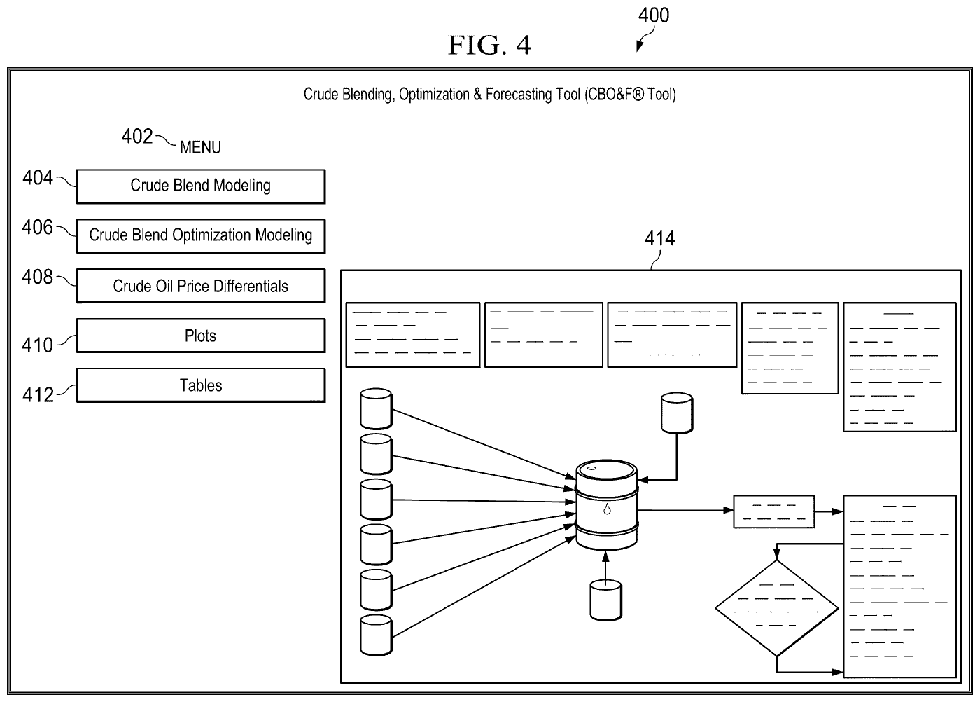

Turning to FIG. 4, FIG. 4 is an illustration 400 of a CBO&F Tool canvas, according to an implementation of the present disclosure.

To illustrate an application of the CBO&F Tool, an example hypothetical petroleum field development is used: FieldA Q₀₁+ [ComplexB Q₀₂+ComplexC Q₀₃]. The development involves a crude blend assessment of 12 fields targeting 34 reservoirs with varying crude oil quality.

In the example, the objectives of the assessment are: 1) assess a resultant life cycle crude grade by blending FieldA producing at rate of Q₀₁ with ComplexB (comprising 3 Fields) producing at a combined rate of Q₀₂ and ComplexC (comprising 8 fields) producing at combined rate of Q₀₃; 2) establish a minimum mixing ratio of diluent feedstock FieldA to achieve a desired crude grade, AL over a production life cycle of combined feedstock; 3) assess an impact of various production optimization and strategies, such as shutting in one or two of the fields with varying crude quality on an overall combined life cycle crude mix; and 4) determine a product price differential impact of a resultant crude blend over the production life cycle of the project for an economic evaluation.

The illustration 400 includes a menu 402 with five modules: 1) crude blending modeling 404; 2) crude blend optimization modeling 406; 3) crude price differentials 408; 4) plots 410; and 5) tables 412. Also present is a visual overview 414 of aspects of the crude blending and optimization (minimum mixing ratio) workflow 300 of FIG. 3.

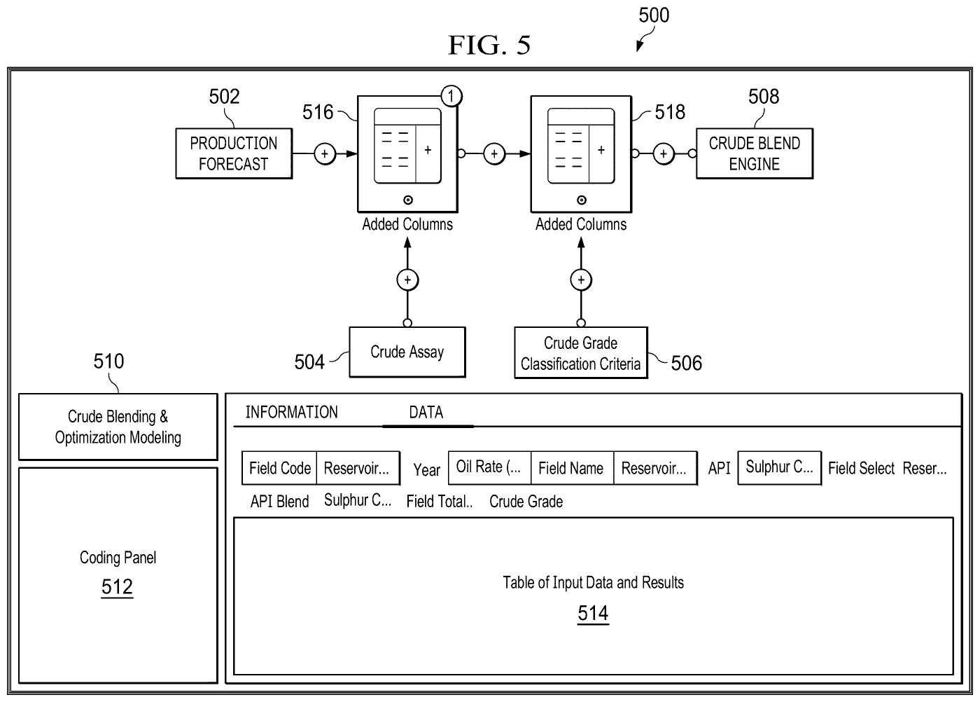

FIG. 5 is an illustration 500 of the CBO&F Tool workflow and CBE, according to an implementation of the present disclosure. In some implementations, the CBO&F Tool workflow and CBE is accessible by selecting 414 (e.g., an image) in the canvas of FIG. 4. In some implementations, the FIG. 5 canvas is accessible from the FIG. 4 canvas using a graphical panel or button (not illustrated) at the bottom left of the visual overview 414.

Illustrated in FIG. 5 is an input canvas including a feedstock production forecast panel 502, crude assay panel 504 and crude oil classification criteria panel 506 are coupled to the crude blend engine (CBE) panel 508. The CBE represented by CBE panel 508 automates blending algorithms for all the crude blend fluid properties estimation, crude grade categorization, forecasting, and optimization solutions. In some implementations, the panels are linked to a production network database for the production forecast panel 502, crude assay panel 504 and the crude grade classification criteria panel 506. The CBE automatically updates when an input database is updated with new data.

Also illustrated is crude blending & optimization modeling panel 510, a coding panel 512, and a table of input data and results 514. The crude blending & optimization modeling panel 510 displays components of algorithm code used in the CBE. The coding panel 512 is an environment where code for the mathematical algorithms is stored. A user can select code for updating or viewing. The table of input data and results 514 is used to display raw input data and results of blended properties.

In some implementations, sub-engine 516 and sub-engine 518 are used to search, match, and link input databases to each other. For example, sub-engine 516 can search and link fields and reservoirs from a production forecast database with crude assay properties, and the second sub-engine 518 can match resultant blended properties to a crude grade classification for the CBE to carry out overall calculations using algorithms as coded in the coding panel 512. “Added columns” associated with sub-engine 516 and sub-engine 518 indicates that other databases can be added if desired.

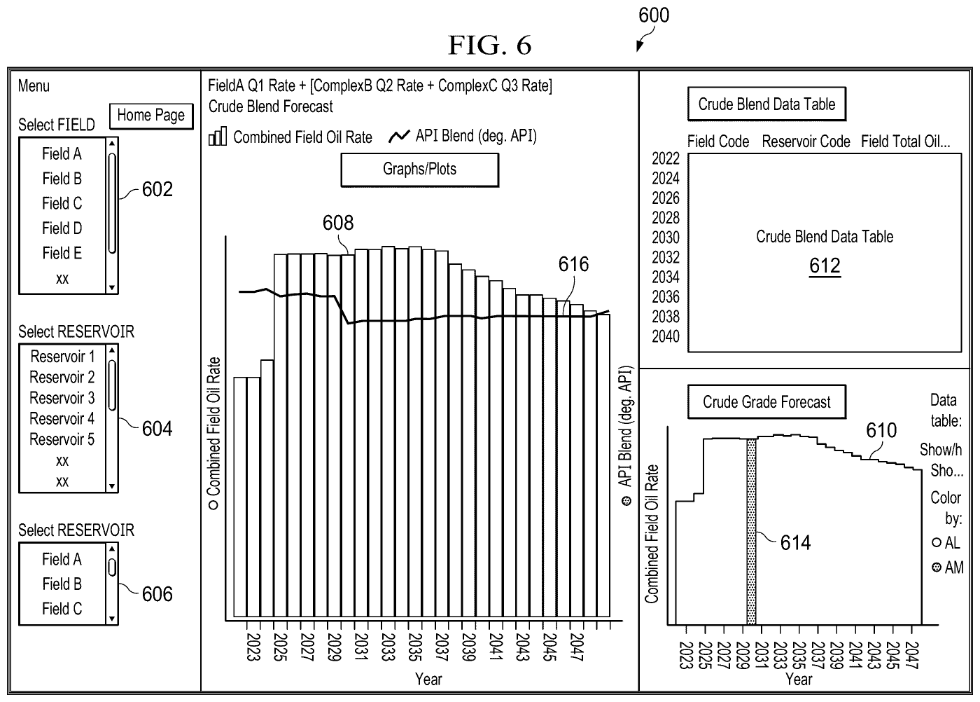

FIG. 6 is an illustration 600 of a CBO&F Tool crude blend modeling canvas, according to an implementation of the present disclosure. For example, in some implementations, a user can select 404 from menu 402 in FIG. 4 to display the canvas of FIG. 6.

A required crude blend is modeled using the canvas of FIG. 6 by selecting required feedstock(s) for a blending assessment. For example: 1) 602 select desired Field(s) (e.g., Field A and Field C); 2) 604 select associated Reservoir(s) (e.g., Reservoir 5); 3) 606 select Field(s) to Graph/Plot and for Data Table visualization.

The CBO&F Tool automatically calculates blended fluid properties (e.g., API gravity and Sulphur content) based on volumetric and mass balance equations previously discussed. Crude grade of the resultant blended properties is categorized based on crude oil classification criteria. Additionally, the CBO&F Tool generates plots for a combined mixed production forecast 608, associated crude grade forecast 610, and a crude blend data table 612.

For the FieldA Q₀₁+[ComplexB Q₀₂+ComplexC Q₀₃] Development example, the resultant crude grade is AL which is maintained through the life cycle as shown in the crude grade forecast 610 above except for one year 614 in which the crude grade is AM. Further, in the combined mixed production forecast 608, the API gravity of the blend is indicated by 616 against the overall combined field oil rate.

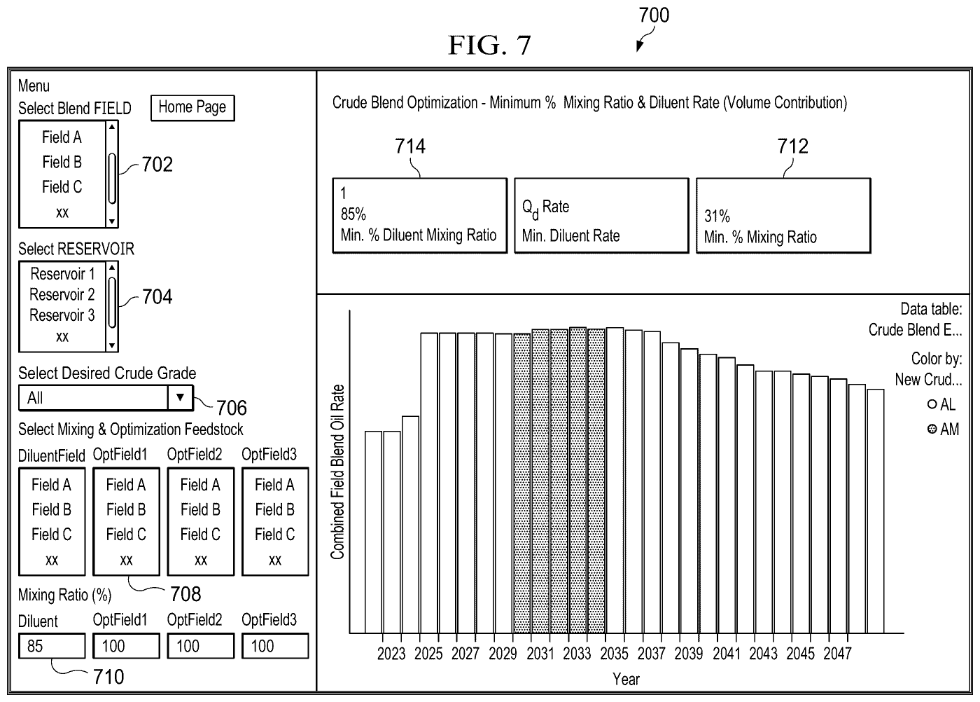

FIG. 7 is an illustration 700 of a CBO&F Tool crude blend optimization modeling canvas, according to an implementation of the present disclosure. For example, in some implementations, a user can select 406 from menu 404 in FIG. 4 to display the canvas of FIG. 7.

A required crude blend optimization is modeled by selecting required feedstock(s) for a blending assessment, a desired crude grade, a diluent and associated feedstock(s) to be optimized. For example, using different panels: 1) 702 select desired Field(s) (e.g., Field C); 2) 704 select associated Reservoir(s) (e.g., Reservoir 2); 3) 706 select a desired or target Crude Grade (e.g., “AL”); 4) 708 select diluent Field(s) and/or Fields(s) to be optimized (e.g., diluent field Field A and optimize Field B from an optimize field 1 (OptField1) selection; and 5) 710 adjust a diluent mixing ratio (e.g., 85% diluent) and/or field(s) optimization factors (e.g., each set to 100%) to achieve a desired life cycle crude grade, production strategy, and production levels.

For the FieldA Q₀₁+ [ComplexB Q₀₂+ComplexC Q₀₃] Development example, a minimum mixing ratio 712 required to maintain life cycle AL crude grade is 31% of the combined mix with 85% (or Q_{od} rate) contribution 714 (entered at 710) from the diluent feedstock (FieldA).

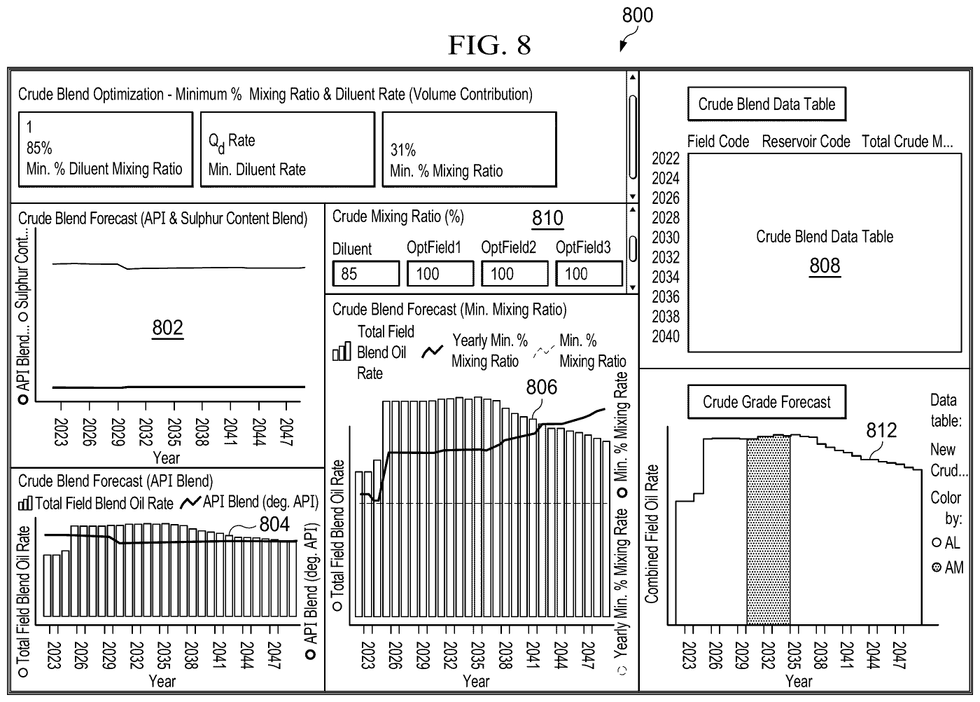

FIG. 8 is an illustration 800 of a CBO&F Tool crude blend optimization modeling and plots canvas, according to an implementation of the present disclosure. In some implementations, the FIG. 8 canvas is accessed by selecting menu 402 item 410 (“Plots”). FIG. 8 shows a dashboard with crude blend matrices, plots, and data table from earlier modelling. Additionally, a minimum mixing ratio and field optimization can also be evaluated.

In some implementations, the FIG. 7 canvas only shows a crude grade forecast outcome based on a modeled crude blend optimization, while the FIG. 8 canvas acts as a dashboard that displays additional plots such as blended forecast of API gravity and Sulphur content over time 802 (top left plot), blended API with blended crude oil production rate forecast over time 804 (bottom left), and crude blend forecast with minimum mixing ratio over time 806 (middle plot).

The FIG. 8 canvas permits a user to plot any matrices or parameters required for further analysis or decision making. The crude blend data table 808 can be used to display actual data used in the plot(s), and a crude mixing ratio panel 810 is analogous to panel 710 on the FIG. 7 canvas. The crude mixing ratio panel 810 is provided for convenience in case a user requires further optimization to be made after the modelling in the FIG. 7 canvas is complete. The crude grade forecast 812 is analogous to 610 on the FIG. 6 canvas.

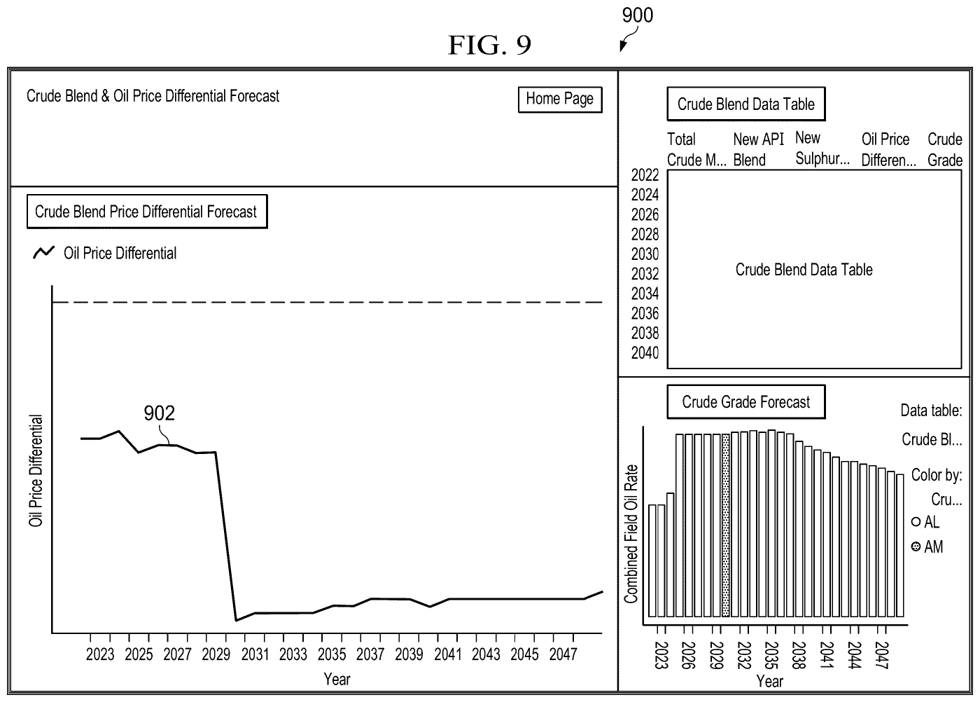

FIG. 9 is an illustration 900 of a CBO&F Tool crude blend product price differential forecast canvas, according to an implementation of the present disclosure. FIG. 9 shows a plot 902 of a product price differential impact of the resultant crude blend of FieldA Q₀₁+[ComplexB Q₀₂+ComplexC Q₀₃] over a production life cycle of the project which can be applied to the diluent product price for economic evaluation.

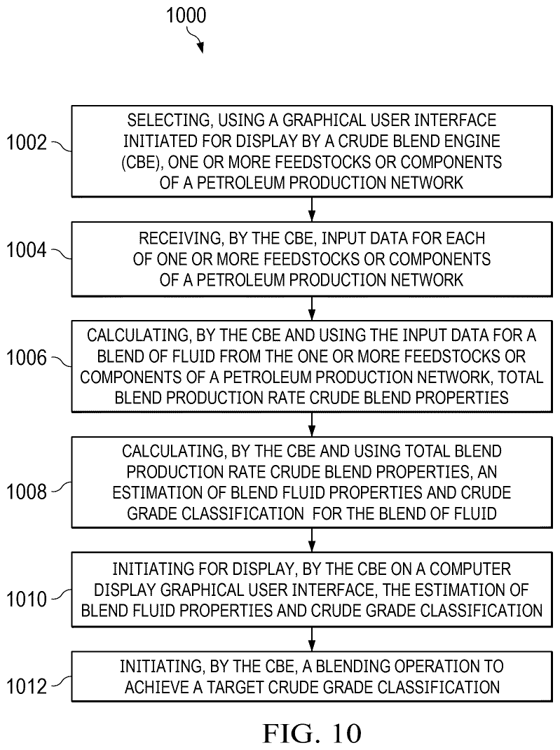

FIG. 10 is a flowchart illustrating an example of a computer-implemented method 1000 for providing a crude blending, optimization, and forecasting tool, according to an implementation of the present disclosure. For clarity of presentation, the description that follows generally describes method 1000 in the context of the other figures in this description. However, it will be understood that method 1000 can be performed, for example, by any system, environment, software, and hardware, or a combination of systems, environments, software, and hardware, as appropriate. In some implementations, various steps of method 1000 can be run in parallel, in combination, in loops, or in any order.

At 1002, using a graphical user interface initiated for display by a crude blend engine (CBE), one or more feedstocks or components of a petroleum production network are selected. From 1002, method 1000 proceeds to 1004.

At 1004, the CBE receives input data for each of one or more feedstocks or components of a petroleum production network. In some implementations, the input data includes oil production forecast, crude fluid properties from a crude assay, crude grade classification criteria, American Petroleum Institute (API) gravity, and Sulphur content. From 1004, method 1000 proceeds to 1006.

At 1006, the CBE calculates, using the input data for a blend of fluid from the one or more feedstocks or components of a petroleum production network, total blend production rate and crude blend properties. In some implementations, the total blend production rate and crude blend properties include the API gravity and the Sulphur content.

In some implementations, the API gravity of the blend is estimated by:

$${X}_{{mix}_{,} j} = \frac{{\sum }_{i = 1}^{n} ( {Q}_{i , j} * {X}_{i , j} )}{{\sum }_{i = 1}^{n} ( {Q}_{i , j} )} ,$$

where Xₘᵢₓ=API of the blend of fluid, Qᵢ=Oil Rate, [symbol] ₒᵢ=Oil specific gravity, i=Feedstock for i=1 to n, j=Time step for j=1 to n years.

In some implementations, the Sulphur content of the blend is estimated by:

$${Y}_{{mix}_{,} j} = \frac{{\sum }_{i = 1}^{n} ( {Q}_{i , j} * {oi , j}_{} * {Y}_{i , j} )}{{\sum }_{i = 1}^{n} ( {Q}_{i , j} * {oi , j}_{} )}$$

where: Yₘᵢₓ=Sulphur Content of the blend of fluid, Qᵢ=Oil Rate, [symbol] ₒᵢ=Oil specific gravity, i=Feedstock for i=1 to n, and j=Time step for j=1 to n years.

From 1006, method 1000 proceeds to 1008.

At 1008, the CBE calculates, using the total blend production rate and crude blend properties, an estimation of blend fluid properties and crude grade classification for the blend of fluid. In some implementations, a crude grade classification is estimated by:

$${Z}_{mix , j} = f ( {X}_{mix , j} , {Y}_{mix , j} ) ,$$

where Xₘᵢₓ=API of the blend of fluid, Yₘᵢₓ=Sulphur Content of the blend of fluid, Zₘᵢₓ=Crude Grade of the blend of fluid, Qᵢ=Oil Rate, [symbol] ₒᵢ=Oil specific gravity, i=Feedstock for i=1 to n, and j=Time step for j=1 to n years.

In some implementations, the CBE initiating for display on a computer display graphical user interface, the estimation of blend fluid properties and crude grade classification includes initiating for display a combined mixed production forecast, associated crude grade profile, and crude blend data table. From 1008, method 1000 proceeds to 1010.

At 1010, the CBE initiates for display the estimation of blend fluid properties and crude grade classification on a computer display graphical user interface. From 1010, method 1000 proceeds to 1012.

At 1012, the CBE initiates a blending operation to achieve a target crude grade classification. In some implementations, the CBE initiates a blending operation to achieve a target crude grade classification includes calculating, for a lighter crude oil or diluent, a minimum mixing ratio or required diluent contribution, respectively, to achieve the target crude grade classification. In some implementations, the blending operation is performed by: i) on-line blending, where the one or more feedstocks or components of a petroleum production network from separate pipelines are mixed in a single export line with an in-line static mixer or mechanical mixing device used for ensuring a homogenous mixture or ii) tank blending, where the one or more feedstocks or components of a petroleum production network are blended in export tanks using a tank mixer for ensuring a homogenous mixture. In some implementations, for a crude assay and properties: on-line blending includes sampling and measurements obtained from an export line, and tank blending includes sampling and measurements obtained from an export tank.

In some implementations, method 1000 includes 1) the CBE introducing, using the target crude grade classification and into the blend of fluid, and as a new blend of fluid, a lighter crude oil or diluent; and 2) the CBE establishing a new crude grade classification of the new blend of fluid by:

$${Z}_{d mix , j} = f ( {X}_{d , mix , j} , {Y}_{d mix , j} ) ,$$

$$Minimize = \frac{{\sum }_{i = 1}^{n} {Q}_{d i , j}}{{\sum }_{i = 1}^{n} {Q}_{mix i , j}} , and$$

$${MR}_{, j}$$

$$Subject to : 0 < {MR}_{, j} \leq 100$$

$$and$$

$$Desired / Target Blend , {}^{‶} {Z}_{{{mix}_{,}}^{″} j} = {}^{‶} {Z}_{{{mix}_{,}}^{″} j} .$$

where: X_{d mix}=API of the new blend of fluid with diluent, Y_{d mix}=Sulphur Content of the new blend of fluid with diluent, Z_{d mix}=Crude Grade of the new blend of fluid with diluent, Q_{d}=Diluent Oil Rate, Qₘᵢₓ=Combined blended Oil Rate with diluent, MR=Mixing Ratio of diluent to combined blended volume, i=Feedstock for i=1 to n, j=Time step for j=1 to n years.

In some implementations, method 1000 includes using the CBE and the crude grade classification criteria to categorize the crude grade classification of the new blend of fluid, where:

$${Z}_{mix , j} = f ( {X}_{i , mix} , {Y}_{i , mix} ) ,$$

where: X_{d mix}=API of the new blend of fluid with diluent, Y_{d mix}=Sulphur Content of the new blend of fluid with diluent, Z_{d mix}=Crude Grade of the new blend of fluid with diluent, i=Feedstock for i=1 to n, and j=Time step for j=1 to n years.

In some implementations, method 1000 includes the CBE calculating a life cycle price differential of the new blend of fluid, where:

$${P}_{d mix , i} = a * {X}_{d , mix , j} - b * {Y}_{d mix , j} - c ,$$

where: P_{d mix}=Price differential of resultant crude mix, X_{d mix}=API of the new blend of fluid with diluent, Y_{d mix}=Sulphur Content of the new blend of fluid with diluent, a, b, c=Coefficients of a multiple regression analysis, j=Time step for j=1 to n years.

After 1012, method 1000 can stop.

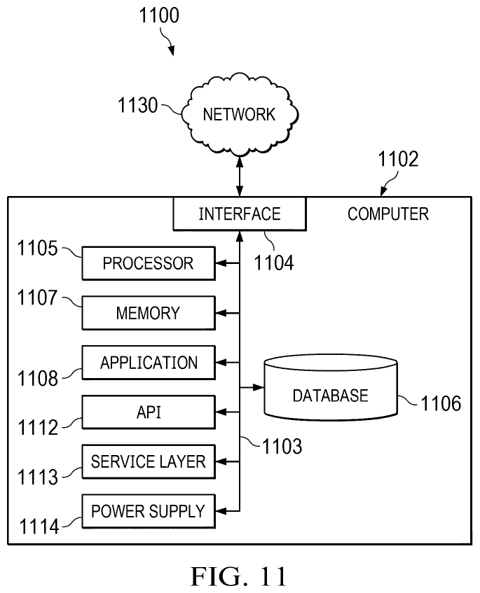

FIG. 11 is a block diagram illustrating an example of a computer-implemented System 1100 used to provide computational functionalities associated with described algorithms, methods, functions, processes, flows, and procedures, according to an implementation of the present disclosure. In the illustrated implementation, computer-implemented system 1100 includes a Computer 1102 and a Network 1130.

The illustrated Computer 1102 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 1102 can include an input device, such as a keypad, keyboard, or touch screen, or a combination of input devices that can accept user information, and an output device that conveys information associated with the operation of the Computer 1102, including digital data, visual, audio, another type of information, or a combination of types of information, on a graphical-type user interface (UI) (or GUI) or other UI.

The Computer 1102 can serve in a role in a distributed computing system as, for example, a client, network component, a server, or a database or another persistency, or a combination of roles for performing the subject matter described in the present disclosure. The illustrated Computer 1102 is communicably coupled with a Network 1130. In some implementations, one or more components of the Computer 1102 can be configured to operate within an environment, or a combination of environments, including cloud-computing, local, or global.

At a high level, the Computer 1102 is an electronic computing device operable to receive, transmit, process, store, or manage data and information associated with the described subject matter. According to some implementations, the Computer 1102 can also include or be communicably coupled with a server, such as an application server, e-mail server, web server, caching server, or streaming data server, or a combination of servers.

The Computer 1102 can receive requests over Network 1130 (for example, from a client software application executing on another Computer 1102) and respond to the received requests by processing the received requests using a software application or a combination of software applications. In addition, requests can also be sent to the Computer 1102 from internal users (for example, from a command console or by another internal access method), external or third-parties, or other entities, individuals, systems, or computers.

Each of the components of the Computer 1102 can communicate using a System Bus 1103. In some implementations, any or all of the components of the Computer 1102, including hardware, software, or a combination of hardware and software, can interface over the System Bus 1103 using an application programming interface (API) 1112, a Service Layer 1113, or a combination of the API 1112 and Service Layer 1113. The API 1112 can include specifications for routines, data structures, and object classes. The API 1112 can be either computer-language independent or dependent and refer to a complete interface, a single function, or even a set of APIs. The Service Layer 1113 provides software services to the Computer 1102 or other components (whether illustrated or not) that are communicably coupled to the Computer 1102. The functionality of the Computer 1102 can be accessible for all service consumers using the Service Layer 1113. Software services, such as those provided by the Service Layer 1113, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 1102, alternative implementations can illustrate the API 1112 or the Service Layer 1113 as stand-alone components in relation to other components of the Computer 1102 or other components (whether illustrated or not) that are communicably coupled to the Computer 1102. Moreover, any or all parts of the API 1112 or the Service Layer 1113 can be implemented as a child or a sub-module of another software module, enterprise application, or hardware module without departing from the scope of the present disclosure.

The Computer 1102 includes an Interface 1104. Although illustrated as a single Interface 1104, two or more Interfaces 1104 can be used according to particular needs, desires, or particular implementations of the Computer 1102. The Interface 1104 is used by the Computer 1102 for communicating with another computing system (whether illustrated or not) that is communicatively linked to the Network 1130 in a distributed environment. Generally, the Interface 1104 is operable to communicate with the Network 1130 and includes logic encoded in software, hardware, or a combination of software and hardware. More specifically, the Interface 1104 can include software supporting one or more communication protocols associated with communications such that the Network 1130 or hardware of Interface 1104 is operable to communicate physical signals within and outside of the illustrated Computer 1102.

The Computer 1102 includes a Processor 1105. Although illustrated as a single Processor 1105, two or more Processors 1105 can be used according to particular needs, desires, or particular implementations of the Computer 1102. Generally, the Processor 1105 executes instructions and manipulates data to perform the operations of the Computer 1102 and any algorithms, methods, functions, processes, flows, and procedures as described in the present disclosure.

The Computer 1102 also includes a Database 1106 that can hold data for the Computer 1102, another component communicatively linked to the Network 1130 (whether illustrated or not), or a combination of the Computer 1102 and another component. For example, Database 1106 can be an in-memory or conventional database storing data consistent with the present disclosure. In some implementations, Database 1106 can be a combination of two or more different database types (for example, a hybrid in-memory and conventional database) according to particular needs, desires, or particular implementations of the Computer 1102 and the described functionality. Although illustrated as a single Database 1106, two or more databases of similar or differing types can be used according to particular needs, desires, or particular implementations of the Computer 1102 and the described functionality. While Database 1106 is illustrated as an integral component of the Computer 1102, in alternative implementations, Database 1106 can be external to the Computer 1102. The Database 1106 can hold and operate on at least any data type mentioned or any data type consistent with this disclosure.

The Computer 1102 also includes a Memory 1107 that can hold data for the Computer 1102, another component or components communicatively linked to the Network 1130 (whether illustrated or not), or a combination of the Computer 1102 and another component. Memory 1107 can store any data consistent with the present disclosure. In some implementations, Memory 1107 can be a combination of two or more different types of memory (for example, a combination of semiconductor and magnetic storage) according to particular needs, desires, or particular implementations of the Computer 1102 and the described functionality. Although illustrated as a single Memory 1107, two or more Memories 1107 or similar or differing types can be used according to particular needs, desires, or particular implementations of the Computer 1102 and the described functionality. While Memory 1107 is illustrated as an integral component of the Computer 1102, in alternative implementations, Memory 1107 can be external to the Computer 1102.

The Application 1108 is an algorithmic software engine providing functionality according to particular needs, desires, or particular implementations of the Computer 1102, particularly with respect to functionality described in the present disclosure. For example, Application 1108 can serve as one or more components, modules, or applications. Further, although illustrated as a single Application 1108, the Application 1108 can be implemented as multiple Applications 1108 on the Computer 1102. In addition, although illustrated as integral to the Computer 1102, in alternative implementations, the Application 1108 can be external to the Computer 1102.

The Computer 1102 can also include a Power Supply 1114. The Power Supply 1114 can include a rechargeable or non-rechargeable battery that can be configured to be either user- or non-user-replaceable. In some implementations, the Power Supply 1114 can include power-conversion or management circuits (including recharging, standby, or another power management functionality). In some implementations, the Power Supply 1114 can include a power plug to permit the Computer 1102 to be plugged into a wall socket or another power source to, for example, power the Computer 1102 or recharge a rechargeable battery.

There can be any number of Computers 1102 associated with, or external to, a computer system containing Computer 1102, each Computer 1102 communicating over Network 1130. Further, the term “client,” “user,” or other appropriate terminology can be used interchangeably, as appropriate, without departing from the scope of the present disclosure. Moreover, the present disclosure contemplates that many users can use one Computer 1102, or that one user can use multiple computers 1102.

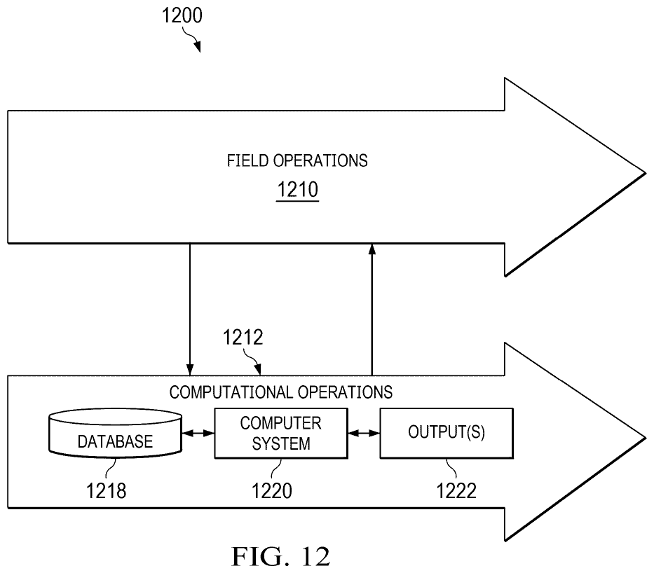

FIG. 12 illustrates hydrocarbon production operations 1200 that include both one or more field operations 1210 and one or more computational operations 1212, which exchange information and control exploration for the production of hydrocarbons. In some implementations, outputs of techniques of the present disclosure can be performed before, during, or in combination with the hydrocarbon production operations 1200, specifically, for example, either as field operations 1210 or computational operations 1212, or both.

Examples of field operations 1210 include forming/drilling a wellbore, hydraulic fracturing, producing through the wellbore, injecting fluids (such as water) through the wellbore, to name a few. In some implementations, methods of the present disclosure can trigger or control the field operations 1210. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1210 and responsively triggering the field operations 1210 including, for example, generating plans and signals that provide feedback to and control physical components of the field operations 1210. Alternatively, or in addition to, the field operations 1210 can trigger the methods of the present disclosure. For example, implementing physical components (including, for example, hardware, such as sensors) deployed in the field operations 1210 can generate plans and signals that can be provided as input or feedback (or both) to the methods of the present disclosure.

Examples of computational operations 1212 include one or more computer systems 1220 that include one or more processors and computer-readable media (e.g., non-transitory computer-readable media) operatively coupled to the one or more processors to execute computer operations to perform the methods of the present disclosure. The computational operations 1212 can be implemented using one or more databases 1218, which store data received from the field operations 1210 and/or generated internally within the computational operations 1212 (e.g., by implementing the methods of the present disclosure) or both. For example, the one or more computer systems 1220 process inputs from the field operations 1210 to assess conditions in the physical world, the outputs of which are stored in the databases 1218. For example, seismic sensors of the field operations 1210 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1212 where they are stored in the databases 1218 and analyzed by the one or more computer systems 1220.

In some implementations, one or more outputs 1222 generated by the one or more computer systems 1220 can be provided as feedback/input to the field operations 1210 (either as direct input or stored in the databases 1218). The field operations 1210 can use the feedback/input to control physical components used to perform the field operations 1210 in the real world.

For example, the computational operations 1212 can process the seismic data to generate three-dimensional (3D) maps of the subsurface formation. The computational operations 1212 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1212 to process new information about the formation and control the drilling to adjust to the observed conditions in real-time.

The one or more computer systems 1220 can update the 3D maps of the subsurface formation as information from one exploration well is received and the computational operations 1212 can adjust the location of the next exploration well based on the updated 3D maps. Similarly, the data received from production operations can be used by the computational operations 1212 to control components of the production operations. For example, production well and pipeline data can be analyzed to predict slugging in pipelines leading to a refinery and the computational operations 1212 can control machine operated valves upstream of the refinery to reduce the likelihood of plant disruptions that run the risk of taking the plant offline.

In some implementations of the computational operations 1212, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

Described implementations of the subject matter can include one or more features, alone or in combination.

For example, in a first implementation, a computer-implemented method for providing a crude blending, optimization, and forecasting tool, comprising: selecting, using a graphical user interface initiated for display by a crude blend engine (CBE), one or more feedstocks or components of a petroleum production network; receiving, by the CBE, input data for each of one or more feedstocks or components of a petroleum production network; calculating, by the CBE and using the input data for a blend of fluid from the one or more feedstocks or components of a petroleum production network, total blend production rate and crude blend properties; calculating, by the CBE and using the total blend production rate and crude blend properties, an estimation of blend fluid properties and crude grade classification for the blend of fluid; initiating for display, by the CBE on a computer display graphical user interface, the estimation of blend fluid properties and crude grade classification; and initiating, by the CBE, a blending operation to achieve a target crude grade classification.

The foregoing and other described implementations can each, optionally, include one or more of the following features:

A first feature, combinable with any of the following features, wherein the input data includes oil production forecast, crude fluid properties from a crude assay, crude grade classification criteria, American Petroleum Institute (API) gravity, and Sulphur content.

A second feature, combinable with any of the previous or following features, wherein the total blend production rate and crude blend properties comprise the API gravity and the Sulphur content.

A third feature, combinable with any of the previous or following features, wherein the API gravity of the blend is estimated by:

$${X}_{{mix}_{,} j} = \frac{{\sum }_{i = 1}^{n} ( {Q}_{i , j} * {X}_{i , j} )}{{\sum }_{i = 1}^{n} ( {Q}_{i , j} )} ,$$

where: Xₘᵢₓ=API of the blend of fluid, Qᵢ=Oil Rate, [symbol] ₒᵢ=Oil specific gravity, i=Feedstock for i=1 to n, j=Time step for j=1 to n years.

A fourth feature, combinable with any of the previous or following features, wherein the Sulphur content of the blend is estimated by:

$${Y}_{{mix}_{,} j} = \frac{{\sum }_{i = 1}^{n} ( {Q}_{i , j} * {oi , j}_{} * {Y}_{i , j} )}{{\sum }_{i = 1}^{n} ( {Q}_{i , j} * {oi , j}_{} )} ,$$

where: Yₘᵢₓ=Sulphur Content of the blend of fluid, Qᵢ=Oil Rate, [symbol] ₒᵢ=Oil specific gravity, i=Feedstock for i=1 to n, and j=Time step for j=1 to n years.

A fifth feature, combinable with any of the previous or following features, wherein a crude grade classification is estimated by:

$${Z}_{mix , j} = f ( {X}_{mix , j} , {Y}_{mix , j} ) ,$$

where: Xₘᵢₓ=API of the blend of fluid, Yₘᵢₓ=Sulphur Content of the blend of fluid, Zₘᵢₓ=Crude Grade of the blend of fluid, Qᵢ=Oil Rate, [symbol] ₒᵢ=Oil specific gravity, i=Feedstock for i=1 to n, and j=Time step for j=1 to n years.

A sixth feature, combinable with any of the previous or following features, wherein the initiating for display, by the CBE on a computer display graphical user interface, the estimation of blend fluid properties and crude grade classification comprises initiating for display a combined mixed production forecast, associated crude grade profile, and crude blend data table.

A seventh feature, combinable with any of the previous or following features, wherein initiating, by the CBE, a blending operation to achieve a target crude grade classification comprises calculating, for a lighter crude oil or diluent, a minimum mixing ratio or required diluent contribution, respectively, to achieve the target crude grade classification.

An eighth feature, combinable with any of the previous or following features, wherein the blending operation is performed by: i) on-line blending, wherein the one or more feedstocks or components of a petroleum production network from separate pipelines are mixed in a single export line with an in-line static mixer or mechanical mixing device used for ensuring a homogenous mixture or ii) tank blending, wherein the one or more feedstocks or components of a petroleum production network are blended in export tanks using a tank mixer for ensuring a homogenous mixture.

A ninth feature, combinable with any of the previous or following features, wherein, for a crude assay and properties: on-line blending includes sampling and measurements obtained from an export line, and wherein, tank blending includes sampling and measurements obtained from an export tank.

A tenth feature, combinable with any of the previous or following features, comprising:
introducing, by the CBE using the target crude grade classification and into the blend of fluid, as a new blend of fluid, a lighter crude oil or diluent; and
establishing, by the CBE, a new crude grade classification of the new blend of fluid, by:

$${Z}_{d mix , j} = f ( {X}_{d , mix , j} , {Y}_{d mix , j} ) ,$$

$$Minimize = \frac{{\sum }_{i = 1}^{n} {Q}_{d i , j}}{{\sum }_{i = 1}^{n} {Q}_{mix i , j}} , and$$

$${MR}_{, j}$$

$$Subject to : 0 < {MR}_{, j} \leq 100$$

$$and$$

$$Desired / Target Blend , {}^{‶} {Z}_{{{mix}_{,}}^{″} j} = {}^{‶} {Z}_{{{mix}_{,}}^{″} j} .$$

where: X_{d mix}=API of the new blend of fluid with diluent, Y_{d mix}=Sulphur Content of the new blend of fluid with diluent, Z_{d mix}=Crude Grade of the new blend of fluid with diluent, Q_{d}=Diluent Oil Rate, Qₘᵢₓ=Combined blended Oil Rate with diluent, MR=Mixing Ratio of diluent to combined blended volume, i=Feedstock for i=1 to n, j=Time step for j=1 to n years.

An eleventh feature, combinable with any of the previous or following features, comprising:
categorizing, using the CBE and the crude grade classification criteria, the crude grade classification of the new blend of fluid, wherein:

$${Z}_{mix , j} = f ( {X}_{i , mix} , {Y}_{i , mix} ) ,$$

where: X_{d mix}=API of the new blend of fluid with diluent, Y_{d mix}=Sulphur Content of the new blend of fluid with diluent, Z_{d mix}=Crude Grade of the new blend of fluid with diluent, i=Feedstock for i=1 to n, and j=Time step for j=1 to n years.

A twelfth feature, combinable with any of the previous or following features, comprising:
calculating, by the CBE, a life cycle price differential of the new blend of fluid, wherein:

$${P}_{d mix , i} = a * {X}_{d , mix , j} - b * {Y}_{d mix , j} - c ,$$

where: P_{d mix}=Price differential of resultant crude mix, X_{d mix}=API of the new blend of fluid with diluent, Y_{d mix}=Sulphur Content of the new blend of fluid with diluent, a, b, c=Coefficients of a multiple regression analysis, j=Time step for j=1 to n years.

In a second implementation, a non-transitory, computer-readable medium storing one or more instructions executable by a computer system to perform one or more operations for providing a crude blending, optimization, and forecasting tool, comprising: selecting, using a graphical user interface initiated for display by a crude blend engine (CBE), one or more feedstocks or components of a petroleum production network; receiving, by the CBE, input data for each of one or more feedstocks or components of a petroleum production network; calculating, by the CBE and using the input data for a blend of fluid from the one or more feedstocks or components of a petroleum production network, total blend production rate and crude blend properties; calculating, by the CBE and using the total blend production rate and crude blend properties, an estimation of blend fluid properties and crude grade classification for the blend of fluid; initiating for display, by the CBE on a computer display graphical user interface, the estimation of blend fluid properties and crude grade classification; and initiating, by the CBE, a blending operation to achieve a target crude grade classification.

The foregoing and other described implementations can each, optionally, include one or more of the following features:

A first feature, combinable with any of the following features, wherein the input data includes oil production forecast, crude fluid properties from a crude assay, crude grade classification criteria, American Petroleum Institute (API) gravity, and Sulphur content.

A second feature, combinable with any of the previous or following features, wherein the total blend production rate and crude blend properties comprise the API gravity and the Sulphur content.

A third feature, combinable with any of the previous or following features, wherein the API gravity of the blend is estimated by:

$${X}_{{mix}_{,} j} = \frac{{\sum }_{i = 1}^{n} ( {Q}_{i , j} * {X}_{i , j} )}{{\sum }_{i = 1}^{n} ( {Q}_{i , j} )} ,$$

where: Xₘᵢₓ=API of the blend of fluid, Qᵢ=Oil Rate, [symbol] ₒᵢ=Oil specific gravity, i=Feedstock for i=1 to n, j=Time step for j=1 to n years.

A fourth feature, combinable with any of the previous or following features, wherein the Sulphur content of the blend is estimated by:

$${Y}_{{mix}_{,} j} = \frac{{\sum }_{i = 1}^{n} ( {Q}_{i , j} * {oi , j}_{} * {Y}_{i , j} )}{{\sum }_{i = 1}^{n} ( {Q}_{i , j} * {oi , j}_{} )} ,$$

where: Yₘᵢₓ=Sulphur Content of the blend of fluid, Qᵢ=Oil Rate, [symbol] ₒᵢ=Oil specific gravity, i=Feedstock for i=1 to n, and j=Time step for j=1 to n years.

A fifth feature, combinable with any of the previous or following features, wherein a crude grade classification is estimated by:

$${Z}_{mix , j} = f ( {X}_{mix , j} , {Y}_{mix , j} ) ,$$

where: Xₘᵢₓ=in API of the blend of fluid, Yₘᵢₓ=Sulphur Content of the blend of fluid, Zₘᵢₓ=Crude Grade of the blend of fluid, Qᵢ=Oil Rate, [symbol] ₒᵢ=Oil specific gravity, i=Feedstock for i=1 to n, and j=Time step for j=1 to n years.

A sixth feature, combinable with any of the previous or following features, wherein the initiating for display, by the CBE on a computer display graphical user interface, the estimation of blend fluid properties and crude grade classification comprises initiating for display a combined mixed production forecast, associated crude grade profile, and crude blend data table.

A seventh feature, combinable with any of the previous or following features, wherein initiating, by the CBE, a blending operation to achieve a target crude grade classification comprises calculating, for a lighter crude oil or diluent, a minimum mixing ratio or required diluent contribution, respectively, to achieve the target crude grade classification.

An eighth feature, combinable with any of the previous or following features, wherein the blending operation is performed by: i) on-line blending, wherein the one or more feedstocks or components of a petroleum production network from separate pipelines are mixed in a single export line with an in-line static mixer or mechanical mixing device used for ensuring a homogenous mixture or ii) tank blending, wherein the one or more feedstocks or components of a petroleum production network are blended in export tanks using a tank mixer for ensuring a homogenous mixture.

A ninth feature, combinable with any of the previous or following features, wherein, for a crude assay and properties: on-line blending includes sampling and measurements obtained from an export line, and wherein, tank blending includes sampling and measurements obtained from an export tank.

A tenth feature, combinable with any of the previous or following features, comprising:
introducing, by the CBE using the target crude grade classification and into the blend of fluid, as a new blend of fluid, a lighter crude oil or diluent; and
establishing, by the CBE, a new crude grade classification of the new blend of fluid, by:

$${Z}_{d mix , j} = f ( {X}_{d , mix , j} , {Y}_{d mix , j} ) ,$$

$$Minimize = \frac{{\sum }_{i = 1}^{n} {Q}_{d i , j}}{{\sum }_{i = 1}^{n} {Q}_{mix i , j}} , and$$

$${MR}_{, j}$$

$$Subject to : 0 < {MR}_{, j} \leq 100$$

$$and$$

$$Desired / Target Blend , {}^{‶} {Z}_{{{mix}_{,}}^{″} j} = {}^{‶} {Z}_{{{mix}_{,}}^{″} j} .$$

where: X_{d mix}=API of the new blend of fluid with diluent, Y_{d mix}=Sulphur Content of the new blend of fluid with diluent, Z_{d mix}=Crude Grade of the new blend of fluid with diluent, Q_{d}=Diluent Oil Rate, Qₘᵢₓ=Combined blended Oil Rate with diluent, MR=Mixing Ratio of diluent to combined blended volume, i=Feedstock for i=1 to n, j=Time step for j=1 to n years.

An eleventh feature, combinable with any of the previous or following features, comprising:
categorizing, using the CBE and the crude grade classification criteria, the crude grade classification of the new blend of fluid, wherein:

$${Z}_{mix , j} = f ( {X}_{i , mix} , {Y}_{i , mix} ) ,$$

where: X_{d mix}=API of the new blend of fluid with diluent, Y_{d mix}=Sulphur Content of the new blend of fluid with diluent, Z_{d mix}=Crude Grade of the new blend of fluid with diluent, i=Feedstock for i=1 to n, and j=Time step for j=1 to n years.

A twelfth feature, combinable with any of the previous or following features, comprising:
calculating, by the CBE, a life cycle price differential of the new blend of fluid, wherein:

$${P}_{d mix , i} = a * {X}_{d , mix , j} - b * {Y}_{d mix , j} - c ,$$

where: P_{d mix}=Price differential of resultant crude mix, X_{d mix}=API of the new blend of fluid with diluent, Y_{d mix}=Sulphur Content of the new blend of fluid with diluent, a, b, c=Coefficients of a multiple regression analysis, j=Time step for j=1 to n years.

In a third implementation, a computer-implemented system for providing a crude blending, optimization, and forecasting tool, comprising: one or more computers; and one or more computer memory devices interoperably coupled with the one or more computers and having tangible, non-transitory, machine-readable media storing one or more instructions that, when executed by the one or more computers, perform one or more operations, comprising: selecting, using a graphical user interface initiated for display by a crude blend engine (CBE), one or more feedstocks or components of a petroleum production network; receiving, by the CBE, input data for each of one or more feedstocks or components of a petroleum production network; calculating, by the CBE and using the input data for a blend of fluid from the one or more feedstocks or components of a petroleum production network, total blend production rate and crude blend properties; calculating, by the CBE and using the total blend production rate and crude blend properties, an estimation of blend fluid properties and crude grade classification for the blend of fluid; initiating for display, by the CBE on a computer display graphical user interface, the estimation of blend fluid properties and crude grade classification; and initiating, by the CBE, a blending operation to achieve a target crude grade classification.

The foregoing and other described implementations can each, optionally, include one or more of the following features:

A first feature, combinable with any of the following features, wherein the input data includes oil production forecast, crude fluid properties from a crude assay, crude grade classification criteria, American Petroleum Institute (API) gravity, and Sulphur content.

A second feature, combinable with any of the previous or following features, wherein the total blend production rate and crude blend properties comprise the API gravity and the Sulphur content.

A third feature, combinable with any of the previous or following features, wherein the API gravity of the blend is estimated by:

$${X}_{{mix}_{,} j} = \frac{{\sum }_{i = 1}^{n} ( {Q}_{i , j} * {X}_{i , j} )}{{\sum }_{i = 1}^{n} ( {Q}_{i , j} )} ,$$

where: Xₘᵢₓ=API of the blend of fluid, Qᵢ=Oil Rate, [symbol] ₒᵢ=Oil specific gravity, i=Feedstock for i=1 to n, j=Time step for j=1 to n years.

A fourth feature, combinable with any of the previous or following features, wherein the Sulphur content of the blend is estimated by:

$${Y}_{{mix}_{,} j} = \frac{{\sum }_{i = 1}^{n} ( {Q}_{i , j} * {oi , j}_{} * {Y}_{i , j} )}{{\sum }_{i = 1}^{n} ( {Q}_{i , j} * {oi , j}_{} )} ,$$

where: Yₘᵢₓ=Sulphur Content of the blend of fluid, Q; =Oil Rate, [symbol] ₒᵢ=Oil specific gravity, i=Feedstock for i=1 to n, and j=Time step for j=1 to n years.

A fifth feature, combinable with any of the previous or following features, wherein a crude grade classification is estimated by:

$${Z}_{mix , j} = f ( {X}_{mix , j} , {Y}_{mix , j} ) ,$$

where: Xₘᵢₓ=API of the blend of fluid, Yₘᵢₓ=Sulphur Content of the blend of fluid, Zₘᵢₓ=Crude Grade of the blend of fluid, Qᵢ=Oil Rate, [symbol] ₒᵢ=Oil specific gravity, i=Feedstock for i=1 to n, and j=Time step for j=1 to n years.

A sixth feature, combinable with any of the previous or following features, wherein the initiating for display, by the CBE on a computer display graphical user interface, the estimation of blend fluid properties and crude grade classification comprises initiating for display a combined mixed production forecast, associated crude grade profile, and crude blend data table.

A seventh feature, combinable with any of the previous or following features, wherein initiating, by the CBE, a blending operation to achieve a target crude grade classification comprises calculating, for a lighter crude oil or diluent, a minimum mixing ratio or required diluent contribution, respectively, to achieve the target crude grade classification.

An eighth feature, combinable with any of the previous or following features, wherein the blending operation is performed by: i) on-line blending, wherein the one or more feedstocks or components of a petroleum production network from separate pipelines are mixed in a single export line with an in-line static mixer or mechanical mixing device used for ensuring a homogenous mixture or ii) tank blending, wherein the one or more feedstocks or components of a petroleum production network are blended in export tanks using a tank mixer for ensuring a homogenous mixture.

A ninth feature, combinable with any of the previous or following features, wherein, for a crude assay and properties: on-line blending includes sampling and measurements obtained from an export line, and wherein, tank blending includes sampling and measurements obtained from an export tank.

A tenth feature, combinable with any of the previous or following features, comprising:
introducing, by the CBE using the target crude grade classification and into the blend of fluid, as a new blend of fluid, a lighter crude oil or diluent; and
establishing, by the CBE, a new crude grade classification of the new blend of fluid, by:

$${Z}_{d mix , j} = f ( {X}_{d , mix , j} , {Y}_{d mix , j} ) ,$$

$$Minimize = \frac{{\sum }_{i = 1}^{n} {Q}_{di , j}}{{\sum }_{i = 1}^{n} {Q}_{mix i , j}} , and$$

$${MR}_{, j}$$

$$Subject to : 0 < {MR}_{, j} \leq 100$$

$$and$$

$$Desired / Target Blend , {}^{‶} {Z}_{{{mix}_{,}}^{″} j} = {}^{‶} {Z}_{{{mix}_{,}}^{″} j} .$$

where: X_{d mix}=API of the new blend of fluid with diluent, Y_{d mix}=Sulphur Content of the new blend of fluid with diluent, Z_{d mix}=Crude Grade of the new blend of fluid with diluent, Q_{d}=Diluent Oil Rate, Qₘᵢₓ=Combined blended Oil Rate with diluent, MR=Mixing Ratio of diluent to combined blended volume, i=Feedstock for i=1 to n, j=Time step for j=1 to n years.

An eleventh feature, combinable with any of the previous or following features, comprising:
categorizing, using the CBE and the crude grade classification criteria, the crude grade classification of the new blend of fluid, wherein:

$${Z}_{mix , j} = f ( {X}_{i , mix} , {Y}_{i , mix} ) ,$$

where: X_{d mix}=API of the new blend of fluid with diluent, Y_{d mix}=Sulphur Content of the new blend of fluid with diluent, Z_{d mix}=Crude Grade of the new blend of fluid with diluent, i=Feedstock for i=1 to n, and j=Time step for j=1 to n years.

A twelfth feature, combinable with any of the previous or following features, comprising:
calculating, by the CBE, a life cycle price differential of the new blend of fluid, wherein:

$${P}_{d mix , j} = a * {X}_{d , mix , j} - b * {Y}_{d mix , j} - c ,$$

where: P_{d mix}=Price differential of resultant crude mix, X_{d mix}=API of the new blend of fluid with diluent, Y_{d mix}=Sulphur Content of the new blend of fluid with diluent, a, b, c=Coefficients of a multiple regression analysis, j=Time step for j=1 to n years.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method for providing a crude blending, optimization, and forecasting tool, comprising:
selecting, using a graphical user interface initiated for display by a crude blend engine (CBE), one or more feedstocks or components of a petroleum production network;
receiving, by the CBE, input data for each of one or more feedstocks or components of a petroleum production network;
calculating, by the CBE and using the input data for a blend of fluid from the one or more feedstocks or components of a petroleum production network, total blend production rate and crude blend properties;
calculating, by the CBE and using the total blend production rate and crude blend properties, an estimation of blend fluid properties and crude grade classification for the blend of fluid;
initiating for display, by the CBE on a computer display graphical user interface, the estimation of blend fluid properties and crude grade classification; and
initiating, by the CBE, a blending operation to achieve a target crude grade classification.

2. The computer-implemented method of claim 1, wherein the input data includes oil production forecast, crude fluid properties from a crude assay, crude grade classification criteria, American Petroleum Institute (API) gravity, and Sulphur content.

3. The computer-implemented method of claim 2, wherein the total blend production rate and crude blend properties comprise the API gravity and the Sulphur content.

4. The computer-implemented method of claim 3, wherein the API gravity of the blend is estimated by:
$${X}_{{mix}_{,} j} = \frac{{\sum }_{i = 1}^{n} ( {Q}_{i , j} * {X}_{i , j} )}{{\sum }_{i = 1}^{n} ( {Q}_{i , j} )} ,$$
where: Xₘᵢₓ=API of the blend of fluid, Qᵢ=Oil Rate, [symbol] ₒᵢ=Oil specific gravity, i=Feedstock for i=1 to n, j=Time step for j=1 to n years.

5. The computer-implemented method of claim 3, wherein the Sulphur content of the blend is estimated by:
$${Y}_{{mix}_{,} j} = \frac{{\sum }_{i = 1}^{n} ( {Q}_{i , j} * {oi , j}_{} * {Y}_{i , j} )}{{\sum }_{i = 1}^{n} ( {Q}_{i , j} * {oi , j}_{} )} ,$$
where: Xₘᵢₓ=Sulphur Content of the blend of fluid, Qᵢ=Oil Rate, [symbol] ₒᵢ=Oil specific gravity, i=Feedstock for i=1 to n, and j=Time step for j=1 to n years.

6. The computer-implemented method of claim 3, wherein a crude grade classification is estimated by:
$${Z}_{mix , j} = f ( {X}_{mix , j} , {Y}_{mix , j} ) ,$$
where: Xₘᵢₓ=API of the blend of fluid, Yₘᵢₓ=Sulphur Content of the blend of fluid, Zₘᵢₓ=Crude Grade of the blend of fluid, Qᵢ=Oil Rate, [symbol] ₒᵢ=Oil specific gravity, i=Feedstock for i=1 to n, and j=Time step for j=1 to n years.

7. The computer-implemented method of claim 3, wherein the initiating for display, by the CBE on a computer display graphical user interface, the estimation of blend fluid properties and crude grade classification comprises initiating for display a combined mixed production forecast, associated crude grade profile, and crude blend data table.

8. The computer-implemented method of claim 2, wherein initiating, by the CBE, a blending operation to achieve a target crude grade classification comprises calculating, for a lighter crude oil or diluent, a minimum mixing ratio or required diluent contribution, respectively, to achieve the target crude grade classification.

9. The computer-implemented method of claim 8, wherein the blending operation is performed by: i) on-line blending, wherein the one or more feedstocks or components of a petroleum production network from separate pipelines are mixed in a single export line with an in-line static mixer or mechanical mixing device used for ensuring a homogenous mixture or ii) tank blending, wherein the one or more feedstocks or components of a petroleum production network are blended in export tanks using a tank mixer for ensuring a homogenous mixture.

10. The computer-implemented method of claim 9, wherein, for a crude assay and properties: on-line blending includes sampling and measurements obtained from an export line, and wherein, tank blending includes sampling and measurements obtained from an export tank.

11. The computer-implemented method of claim 8, comprising:
introducing, by the CBE using the target crude grade classification and into the blend of fluid, as a new blend of fluid, a lighter crude oil or diluent; and
establishing, by the CBE, a new crude grade classification of the new blend of fluid, by:
$${Z}_{d mix , j} = f ( {X}_{d , mix , j} , {Y}_{d mix , j} ) ,$$
$$Minimize = \frac{{\sum }_{i = 1}^{n} {Q}_{di , j}}{{\sum }_{i = 1}^{n} {Q}_{mix i , j}} , and$$
$${MR}_{, j}$$
$$Subject to : 0 < {MR}_{, j} \leq 100$$
$$and$$
$$Desired / Target Blend , {}^{‶} {Z}_{{{mix}_{,}}^{″} j} = {}^{‶} {Z}_{{{mix}_{,}}^{″} j} .$$
where: X_{d mix}=API of the new blend of fluid with diluent, Y_{d mix}=Sulphur Content of the new blend of fluid with diluent, Z_{d mix}=Crude Grade of the new blend of fluid with diluent, Q_{d}=Diluent Oil Rate, Qₘᵢₓ=Combined blended Oil Rate with diluent, MR=Mixing Ratio of diluent to combined blended volume, i=Feedstock for i=1 to n, j=Time step for j=1 to n years.

12. The computer-implemented method of claim 11, comprising:
categorizing, using the CBE and the crude grade classification criteria, the crude grade classification of the new blend of fluid, wherein:
$${Z}_{mix , j} = f ( {X}_{i , mix} , {Y}_{i , mix} ) ,$$
where: X_{d mix}=API of the new blend of fluid with diluent, Y_{d mix}=Sulphur Content of the new blend of fluid with diluent, Z_{d mix}=Crude Grade of the new blend of fluid with diluent, i=Feedstock for i=1 to n, and j=Time step for j=1 to n years.

13. The computer-implemented method of claim 12, comprising:
calculating, by the CBE, a life cycle price differential of the new blend of fluid, wherein:
$${P}_{d mix , j} = a * {X}_{d , mix , j} - b * {Y}_{d mix , j} - c ,$$
where: P_{d mix}=Price differential of resultant crude mix, X_{d mix}=API of the new blend of fluid with diluent, Y_{d mix}=Sulphur Content of the new blend of fluid with diluent, a, b, c=Coefficients of a multiple regression analysis, j=Time step for j=1 to n years.

14. A non-transitory, computer-readable medium storing one or more instructions executable by a computer system to perform one or more operations for providing a crude blending, optimization, and forecasting tool, comprising:
selecting, using a graphical user interface initiated for display by a crude blend engine (CBE), one or more feedstocks or components of a petroleum production network;
receiving, by the CBE, input data for each of one or more feedstocks or components of a petroleum production network;
calculating, by the CBE and using the input data for a blend of fluid from the one or more feedstocks or components of a petroleum production network, total blend production rate and crude blend properties;
calculating, by the CBE and using the total blend production rate and crude blend properties, an estimation of blend fluid properties and crude grade classification for the blend of fluid;
initiating for display, by the CBE on a computer display graphical user interface, the estimation of blend fluid properties and crude grade classification; and
initiating, by the CBE, a blending operation to achieve a target crude grade classification.

15. The non-transitory, computer-readable medium of claim 14, wherein the input data includes oil production forecast, crude fluid properties from a crude assay, crude grade classification criteria, American Petroleum Institute (API) gravity, and Sulphur content.

16. The non-transitory, computer-readable medium of claim 15, wherein the total blend production rate and crude blend properties comprise the API gravity and the Sulphur content.

17. The non-transitory, computer-readable medium of claim 16, wherein the API gravity of the blend is estimated by:
$${X}_{{mix}_{,} j} = \frac{{\sum }_{i = 1}^{n} ( {Q}_{i , j} * {X}_{i , j} )}{{\sum }_{i = 1}^{n} ( {Q}_{i , j} )} ,$$
where: Xₘᵢₓ=API of the blend of fluid, Qᵢ=Oil Rate, [symbol] ₒᵢ=Oil specific gravity, i=Feedstock for i=1 to n, j=Time step for j=1 to n years.

18. The non-transitory, computer-readable medium of claim 16, wherein the Sulphur content of the blend is estimated by:
$${Y}_{{mix}_{,} j} = \frac{{\sum }_{i = 1}^{n} ( {Q}_{i , j} * {oi , j}_{} * {Y}_{i , j} )}{{\sum }_{i = 1}^{n} ( {Q}_{i , j} * {oi , j}_{} )} ,$$
where: Yₘᵢₓ=Sulphur Content of the blend of fluid, Qᵢ=Oil Rate, [symbol] ₒᵢ=Oil specific gravity, i=Feedstock for i=1 to n, and j=Time step for j=1 to n years.

19. The non-transitory, computer-readable medium of claim 16, wherein a crude grade classification is estimated by:
$${Z}_{mix , j} = f ( {X}_{mix , j} , {Y}_{mix , j} ) ,$$
where: Xₘᵢₓ=API of the blend of fluid, Yₘᵢₓ=Sulphur Content of the blend of fluid, Zₘᵢₓ=Crude Grade of the blend of fluid, Qᵢ=Oil Rate, [symbol] ₒᵢ=Oil specific gravity, i=Feedstock for i=1 to n, and j=Time step for j=1 to n years.

20. A computer-implemented system for providing a crude blending, optimization, and forecasting tool, comprising:
one or more computers; and
one or more computer memory devices interoperably coupled with the one or more computers and having tangible, non-transitory, machine-readable media storing one or more instructions that, when executed by the one or more computers, perform one or more operations, comprising:
selecting, using a graphical user interface initiated for display by a crude blend engine (CBE), one or more feedstocks or components of a petroleum production network;
receiving, by the CBE, input data for each of one or more feedstocks or components of a petroleum production network;
calculating, by the CBE and using the input data for a blend of fluid from the one or more feedstocks or components of a petroleum production network, total blend production rate and crude blend properties;
calculating, by the CBE and using the total blend production rate and crude blend properties, an estimation of blend fluid properties and crude grade classification for the blend of fluid;
initiating for display, by the CBE on a computer display graphical user interface, the estimation of blend fluid properties and crude grade classification; and
initiating, by the CBE, a blending operation to achieve a target crude grade classification.
